(19) United States
(12) Patent Application Publication
(10) Pub. No.: US 2018/0092381 A1
(43) Pub. Date: Apr. 5, 2018

(54) MOUTHFEEL BLENDS FOR LOW AND NON-CALORIC BEVERAGES

(71) Applicant: PepsiCo, Inc., Purchase, NY (US)

(72) Inventors: Khushal BRIJWANI, Elmsford, NY (US); Jung Min KIM, Bronx, NY (US); Rajesh Venkata POTINENI, Roscoe, IL (US)

(73) Assignee: PepsiCo, Inc., Purchase, NY (US)

(21) Appl. No.: 15/285,155

(22) Filed: Oct. 4, 2016

(51) Int. Cl. A23L 2/52; A23L 2/60

(52) U.S. Cl. CPC A23L 2/52; A23V 2002/00; A23L 2/60

(57) ABSTRACT

The present disclosure provides a composition for improving mouthfeel of beverages, comprising: a hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000. Also provided are methods of improving the mouthfeel of a beverage product by adding to it a composition of the disclosure.

### FIELD OF THE DISCLOSURE

The present disclosure is generally directed to novel mixtures of hydrolyzed fibrous polysaccharides that are useful for enhancing the mouthfeel of a beverage.

### BACKGROUND

Food and beverage manufacturers have been interested in natural, lower calorie or zero-caloric beverages. Such beverages typically replace some or all of a nutritive sweetener such as sugar or corn syrup with one or more non-nutritive sweeteners. However, replacing nutritive sweeteners with potent non-nutritive sweeteners has faced obstacles due to off-tastes associated with these sweeteners, including bitterness, astringency, licorice flavor, metallic taste, and/or lingering aftertastes; and a perceptible difference in the mouthfeel of the resulting beverages compared to beverages containing nutritive sweeteners. Perceptibly different elements of mouthfeel include thinness and a lack of lubricity. Thus, there remains a need to develop additives for beverages sweetened with non-nutritive/high potency sweeteners that better mimic the mouthfeel of nutritive sweeteners such as sugar.

### BRIEF SUMMARY

In various embodiments, the present disclosure provides a composition for improving mouthfeel of beverages, comprising a hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000.

In one embodiment, the hydrolyzed beta-glucan is characterized by an average molecular weight (M_{w}) of about 100,000 to 300,000. The beta-glucan and arabinoxylan can be enzymatically hydrolyzed. The compositions of the invention can be provided in dry form, in a concentrate or in a solution comprising water.

Another aspect of the invention is directed to a beverage composition, comprising:

water;

a non-nutritive sweetener; and

a composition for improving mouthfeel comprising hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000.

In one embodiment, the beverage composition is a low-calorie or zero-calorie beverage product.

In certain embodiments, the beverage composition is a beverage concentrate. In other embodiments the beverage composition is a ready-to-drink beverage.

Another aspect of the invention is directed to a method of improving mouthfeel attributes of a low-calorie or zero-calorie beverage, comprising adding to a low calorie or zero calorie beverage a composition comprising hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000.

### BRIEF DESCRIPTION OF THE DRAWINGS/FIGURES

The foregoing summary, as well as the following detailed description of the embodiments, will be better understood when read in conjunction with the appended figures. For the purpose of illustration, the figures may describe the use of specific embodiments. It should be understood, however, that the compounds, formulations, compositions, and methods described herein are not limited to the precise embodiments discussed or described in the figures.

FIG. 1 depicts viscosity as a function of concentration of a hydrolyzed β-glucan (βG) and a hydrolyzed arabinoxylan (ARX), each in a citrate buffer solution. The shaded region depicts a viscosity gap between a mock diet beverage {mock Diet (low)} and a mock regularly sweetened beverage {mock Regular (high)}.

FIG. 2A depicts lubrication curves for β-glucan (βG) and FIG. 2B depicts lubrication curves for arabinoxylan (ARX) at varying concentrations in mock Diet.

FIG. 3 depicts the effect of enzyme treatment as a function or time. Cellulase was fixed at 1 μg per 20 mg of β-glucan and hemicellulase was fixed at 10 μg per 20 mg of arabinoxylan.

FIG. 4 depicts the impact of enzyme kinetics on polymeric solution behavior.

FIGS. 5A, 5B and 5C are schematics of modulation caused by either arabinoxylan (ARX) alone (FIG. 5A) or β-glucan (βG) alone (FIG. 5B), and by a combination of both (FIG. 5C).

### DETAILED DESCRIPTION

In various embodiments, the present disclosure provides a composition for improving mouthfeel of beverages, comprising a hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000.

In one embodiment, the hydrolyzed beta-glucan is characterized by an average molecular weight (M_{w}) of about 100,000 to 300,000.

In one embodiment, the hydrolyzed arabinoxylan is characterized by an average molecular weight (M_{w}) of about 100,000 to about 300,000.

The beta-glucan and arabinoxylan can be enzymatically hydrolyzed. In some embodiments, the enzymatically hydrolyzed beta-glucan is hydrolyzed with β-1-4-endo glucanase (also referred as cellulase or endocellulase). Alternatively, the beta-glucan can be hydrolyzed with β-1,3-1,4 endoglucanase (also referred to as β-glucanase or lichinase). In some embodiments, the enzymatically hydrolyzed arabinoxylan is endo-aribinase or endo-xylanase hydrolyzed.

In some embodiments, the weight ratio of the hydrolyzed beta-glucan to the hydrolyzed arabinoxylan ranges from about 10:1 to about 1:10.

The compositions of the invention can be provided in dry form, in a concentrate or in a solution comprising water.

In embodiments where the composition is a solution, the hydrolyzed beta-glucan and the hydrolyzed arabinoxylan are each present in an amount of about 0.1 mg/mL to about 1 mg/mL.

Another aspect of the invention is directed to a beverage composition, comprising:

water;

a non-nutritive sweetener; and

a composition for improving mouthfeel as described above.

In one embodiment, the beverage composition a low-calorie or zero-calorie beverage product.

In certain embodiments, the non-nutritive sweetener is selected from the group consisting of aspartame, acesulfame salts, saccharins, cyclamates, sucralose, alitame, neotame, steviosides, glycyrrhizin, Lo Han Guo, neohesperidin dihydrochalcone, monatin, monellin, thaumatin and brazzein. In another embodiment, the non-nutritive sweetener is selected from the group consisting of sucrose, aspartame, sucralose, acesulfame salts, and mixtures thereof.

In one embodiment, the beverage composition comprises aspartame as the non-nutritive sweetener.

In one embodiment, the beverage composition comprises sucralose as the non-nutritive sweetener.

In certain embodiments, the water in the beverage composition is carbonated water.

The beverage composition can include a cola flavorant.

The beverage composition can further include an acidulant selected from the group consisting of phosphoric acid, citric acid, malic acid, tartaric acid, lactic acid, formic acid, ascorbic acid, fumaric acid, gluconic acid, succinic acid, maleic acid, adipic acid, and mixtures thereof; wherein the pH of the beverage ranges about 2 to about 5. In one embodiment, the acidulant is phosphoric acid.

The beverage composition can include a tea flavorant.

The beverage composition can include a coffee flavorant.

The beverage composition can include a fruit juice.

In certain embodiments, the beverage composition is substantially caffeine free. In other embodiments, the beverage composition includes caffeine.

In certain embodiments, the enzymatically hydrolyzed beta-glucan is provided in an amount of about 0.1 mg/mL to about 5 mg/mL; and the enzymatically hydrolyzed arabinoxylan is provided in an amount of about 0.1 mg/mL to about 5 mg/mL.

In one embodiment, the beverage composition has a viscosity in the range of about 0.5 to about 5 cP, a friction coefficient in the range of about 0.001 to about 2 when 50 Duro PDMS sphere and disc are used as measurement rigs on a PCS Instruments MTM2 tribometer at a normal load of 2.0 N, and/or a contact angle in the range of about 50° to about 80°.

In certain embodiments, the beverage composition is a beverage concentrate. In such beverage concentrates, the enzymatically hydrolyzed beta-glucan can be in an amount sufficient to provide about 0.1 mg/mL to about 5 mg/mL of the beta-glucan in a ready-to-drink beverage product that is prepared by diluting the beverage concentrate by a 1-plus-5 throw with water. Also, in such embodiments, the enzymatically hydrolyzed arabinoxylan is in an amount sufficient to provide about 0.1 mg/mL to about 5 mg/mL of the arabinoxylan in a ready-to-drink beverage product prepared by diluting the beverage concentrate by a 1-plus-5 throw with water.

Another aspect of the invention is directed to a method of improving taste attributes of a low-calorie or zero-calorie beverage, comprising adding to a low calorie or zero calorie beverage a composition for improving mouthfeel of beverages as described above.

### Definitions

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there are alternative embodiments which are not excluded.

Unless otherwise indicated or unless otherwise clear from the context in which it is described, alternative and optional elements or features in any of the disclosed embodiments and examples are interchangeable with each other. That is, an element described in one embodiment or example should be understood to be interchangeable or substitutable for one or more corresponding but different elements in another described example or embodiment and, likewise, an optional feature of one embodiment or example may optionally also be used in other embodiments and examples. More generally, the elements and features of any disclosed example or embodiment should be understood to be disclosed generally for use with other aspects and other examples and embodiments. A reference to a component or ingredient being operative or configured to perform one or more specified functions, tasks and/or operations or the like, is intended to mean that it can perform such function(s), task(s), and/or operation(s) in at least certain embodiments, and may well be able to perform also one or more other functions, tasks, and/or operations.

The articles “a,” “an,” and “the” are used herein to refer to one or to more than one (i.e., to at least one) of the grammatical object of the article. By way of example, “an element” means one element or more than one element.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also provided.

As used herein, the term “about” means±10% of the noted value. By way of example only, a composition comprising “about 30 weight percent” of a compound could include from 27 weight percent of the compound up to and including 33 weight percent of the compound.

The terms “beverage concentrate,” “concentrate,” and “syrup” are used interchangeably throughout this disclosure and refer to an aqueous beverage composition suitable for use in beverage preparation. Exemplary embodiments are described elsewhere in this disclosure.

As used herein, “taste” refers to a combination of sweetness perception, temporal effects of sweetness perception, i.e., on-set and duration, off-tastes, e.g. bitterness and metallic taste, residual perception (aftertaste), and tactile perception, e.g. body and thickness.

The term “nutritive sweetener” refers generally to sweeteners which provide significant caloric content in typical usage amounts, e.g., more than about 5 calories per 8 oz. serving of a beverage.

As used herein, the term “non-nutritive sweetener” refers to all sweeteners other than nutritive sweeteners.

As used herein, a “full-calorie” beverage formulation is one fully sweetened with a nutritive sweetener.

As used herein, a “low-calorie beverage” has fewer than 40 calories per 8 oz. serving of beverage.

As used herein, “zero-calorie” means having less than 5 calories per serving per 8 oz. for beverages.

As used in this disclosure, unless otherwise specified, the term “added,” “combined,” and terms of similar character mean that the multiple ingredients or components referred to (e.g., one or more sweeteners, sweetness enhancers, etc.) are combined in any manner and in any order, with or without stirring.

Trends relating to health concerns as well as consumer acceptability and perception have impacted soft-drink consumption, for example, regular cola consumption, and has resulted in larger acceptance of diet colas and sugar-less beverages. Though diet beverages provide healthier benefits such as reduced sugar and sometimes almost zero calories compared to regular beverages, their mouthfeel is far from being perceived as “complete” when compared to regular beverages. As demonstrated by analytical characterization, diet beverages possess lower viscosities and weaker lubrication curves compared to regular beverages. Such a deviation in mouthfeel is largely driven by sugar concentration, which imparts not only sweetness but also a rich mouthfeel that is often recognized as syrupiness. Hence, this poses a great challenge to the formulation of low-sugar beverages having the same or similar mouthfeel as that of regular beverages.

The present disclosure relates to hydrolyzed fibrous polysaccharides like β-glucan and arabinoxylan to provide a syrupy mouthfeel of regular beverages into diet beverages. While not wishing to be bound by theory, these two fibrous polysaccharides are unique in their mouthfeel delivery for the following reasons: 1) they provide bulk to the beverage by increasing viscosity; and 2) due to their structural orientation and large polymeric weight they facilitate lubrication as evident from reduced coefficients of friction.

In various embodiments, the present disclosure provides a composition for improving mouthfeel of beverages, comprising a hydrolyzed beta-glucan characterized by an average molecular weight (M_{w}) of about 50,000 to 350,000; and a hydrolyzed arabinoxylan, characterized by an average molecular weight (M_{w}) of about 50,000 to about 350,000.

Beta-glucan occurs in quantity in the cell wall fibers of oats and barley grain. Beta-glucan is a polysaccharide comprising D-glucan units and is the main structural material in the cell walls of barley and oat grain. Beta-glucan is a non-starchy polysaccharide in which individual glucose molecules, or glucans, are linked by beta(13) linkages, beta(14) linkages or a mix of beta(13), and beta(14) linkages.

A beta-glucan component from any cereal grain can be used as a starting material in the present invention. Such cereal grains include, but are not limited to, barley, oats, wheat, rice, rye, corn, sorghum and millet. Oats and barley are preferred because of their higher levels of naturally occurring beta-glucan. For example, oat grain has a 4% by weight beta-glucan content while barley grain has a 5-7% by weight beta-glucan content. Typically, a beta glucan having an average molecular weight of about 300,000 Daltons to about 400,000 Daltons Daltons is employed as a starting material to form a hydrolyzed beta-glucan employed in the present disclosure. For example, useful starting materials include beta glucan having an average molecular weight of about 300,000, 325,000, 350,000, 375,000 or 400,000 Daltons.

In one embodiment, the hydrolyzed beta-glucan is characterized by an average molecular weight (M_{w}) of about 100,000 to 400,000 Daltons. The beta-glucan starting material is hydrolyzed by methods available in the art. In some embodiments, the beta-glucan is enzymatically hydrolyzed. The enzymatically hydrolyzed beta-glucan can be hydrolyzed with β-1-4-endo glucanase (also referred as cellulase or endocellulase). Alternatively, the beta-glucan can be hydrolyzed with β-1,3-1,4 endoglucanase (also referred to as β-glucanase or lichinase) A suitable enzyme is β-1-4-endo glucanase (or endocellulase, also commonly referred as cellulose). The beta-glucan is hydrolyzed to form polymeric fragments having an average molecular weight (M_{w}) of about 50,000 to about 350,000 Daltons. In one embodiment, the hydrolyzed beta-glucan is characterized by an average molecular weight of about 100,000 to about 300,000 Daltons. In one embodiment, the hydrolyzed beta-glucan is characterized by an average molecular weight of about 150,000 to 350,000 Daltons. In another embodiment, the hydrolyzed beta-glucan is characterized by an average molecular weight of about 50,000 to 200,000 Daltons. In yet another embodiment, the hydrolyzed beta-glucan is characterized by an average molecular weight of about 180,000 to 400,000 Daltons.

Arabinoxylan is a polysaccharide composed of xylose and arabinose. It is part of the water soluble and insoluble fiber present in cereals, in particular in the cell walls. Arabinoxylan consist of alpha-L-arabinofuranose residues attached as branch-points to a beta-(1-4)-linked xylose polymeric backbone. The xylose residues may be mono-substituted in the C2- or C3-position or di-substituted at both the C2- and C3-position. In addition, ferulic acid and p-coumaric acid may be covalently linked to arabinoxylan via esterification at the C5 position of some of the arabinosyl units.

The arabinoxylan starting material employed in compositions of the disclosure is a soluble arabinoxylan. The arabinoxylan is obtained from cereal grain, e.g. such as milled grain or by-products from processing of cereal grain, e.g. an arabinoxylan containing by-product from wet- or dry-milling of cereal. The cereal grain may be any cereal grain though preferred is a cereal grain selected from the group consisting of corn (maize), wheat, barley, oat, rice, sorghum and millet. A useful starting material for the present invention is an arabinoxylan containing substrate derived from wheat (more specifically wheat bran), that has an average molecular weight of about 300,000 to about 400,000 Daltons. For example, useful starting materials include beta glucan having an average molecular weight of about 300,000, 325,000, 350,000, 375,000 or 400,000 Daltons.

In one embodiment, the hydrolyzed arabinoxylan is characterized by an average molecular weight (M_{w}) of about 100,000 to about 400,000. In one embodiment, the hydrolyzed arabinoxylan is characterized by an average molecular weight (M_{w}) of about 50,000 to about 350,000 Daltons. In one embodiment, the hydrolyzed beta-glucan is characterized by an average molecular weight of about 100,000 to about 300,000 Daltons. In another embodiment, the hydrolyzed arabinoxylan is characterized by an average molecular weight of about 150,000 to 350,000 Daltons. In yet another embodiment, the hydrolyzed arabinoxylan is characterized by an average molecular weight of about 180,000 to 400,000 Daltons.

The arabinoxylan can be enzymatically hydrolyzed. In some embodiments, the enzymatically hydrolyzed arabinoxylan is endo-aribinase or endo-xylanase hydrolyzed.

In some embodiments, the weight ratio of the hydrolyzed beta-glucan to the hydrolyzed arabinoxylan ranges from about 10:1 to about 1:10. In other embodiments useful ratio of hydrolyzed beta-glucan to the hydrolyzed arabinoxylan is from about 1 to about 7, about 1 to about 3, and about 1 to about 2.

The compositions of the invention can be provided in dry form, in a concentrate or in a solution comprising water.

In embodiments where the composition is a solution that can be added to form beverage compositions, the hydrolyzed beta-glucan and the hydrolyzed arabinoxylan are each present in an amount of about 0.01 mg/mL to about 1 mg/mL. In one embodiment the the hydrolyzed beta-glucan is present in an amount of about 0.01 mg/mL to about 0.7 mg/mL the hydrolyzed beta-glucan is present in an amount of about 0.05 mg/mL to about 0.5 mg/mL the hydrolyzed arabinoxylan is present in an amount of about 0.01 mg/mL to about 0.67 mg/mL the hydrolyzed arabinoxylan is present in an amount of about 0.03 mg/mL to about 0.25 mg/mL

Another aspect of the invention is directed to a beverage composition, comprising:

water;

a non-nutritive sweetener; and

a composition for improving mouthfeel as described above.

In one embodiment, the beverage composition a low-calorie or zero-calorie beverage product.

In certain embodiments, the non-nutritive sweetener is selected from the group consisting of aspartame, acesulfame salts, saccharins, cyclamates, sucralose, alitame, neotame, steviosides, glycyrrhizin, Lo Han Guo, neohesperidin dihydrochalcone, monatin, monellin, thaumatin and brazzein. In another embodiment, the non-nutritive sweetener is selected from the group consisting of sucrose, aspartame, sucralose, acesulfame salts, and mixtures thereof.

In one embodiment, the beverage composition comprises aspartame as the non-nutritive sweetener.

In one embodiment, the beverage composition comprises sucralose as the non-nutritive sweetener.

In certain embodiments, the water in the beverage composition is carbonated water.

The beverage composition can include a cola flavorant.

The beverage composition can further include an acidulant selected from the group consisting of phosphoric acid, citric acid, malic acid, tartaric acid, lactic acid, formic acid, ascorbic acid, fumaric acid, gluconic acid, succinic acid, maleic acid, adipic acid, and mixtures thereof; wherein the pH of the beverage ranges about 2 to about 5. In one embodiment, the acidulant is phosphoric acid

The beverage composition can include a tea flavorant.

The beverage composition can include a coffee flavorant.

The beverage composition can include a fruit juice.

In certain embodiments, the beverage composition is substantially caffeine free. In other embodiments, the beverage composition includes caffeine.

In certain embodiments, the enzymatically hydrolyzed beta-glucan is provided in a ready-to-drink beverage in an amount of about 0.1 mg/mL to about 5 mg/mL; and the enzymatically hydrolyzed arabinoxylan is provided in an amount of about 0.1 mg/mL to about 5 mg/mL. In some embodiments, enzymatically hydrolyzed beta-glucan is provided in an amount of about 0.1 mg/mL to about 0.5 mg/mL, about 0.25 mg/mL to about 0.4 mg/mL, and about 0.7 mg/mL to about 1 mg/mL. In some embodiments enzymatically hydrolyzed arabinoxylan is provided in an amount of about 0.1 mg/mL to about 0.2 mg/mL, about 0.5 mg/mL to about 0.75 mg/mL, and about 0.6 mg/mL to about 1 mg/mL.

In one embodiment, the beverage composition has a viscosity in the range of about 0.5 to about 5 cP, a friction coefficient in the range of about 0.0001 to about 2 when 50 Duro PDMS sphere and disc are used as measurement rigs on a PCS Instruments MTM2 tribometer at a normal load of 2.0 N, and/or a contact angle in the range of about 50° to about 80°. Useful viscosity ranges include about 0.8 cP to about 1.3 cP, about 1 cP to about 1.5 cP, and about 2.2 cP to about 3.5 cP. Useful friction of coefficient ranges include about 0.001 to about 0.8, about 0.01 to about 1.3 and about 0.001 to about 0.4. Useful ranges of contact angle include about 72° to about 80°, and about 50° to about 60°.

In certain embodiments, the beverage composition is a beverage concentrate. In such beverage concentrates, the enzymatically hydrolyzed beta-glucan can be in an amount sufficient to provide about 0.1 mg/mL to about 5 mg/mL of the beta-glucan in a ready-to-drink beverage product that is prepared by diluting the beverage concentrate by a 1-plus-5 throw with water. Also, in such embodiments, the enzymatically hydrolyzed arabinoxylan is in an amount sufficient to provide about 0.1 mg/mL to about 5 mg/mL of the arabinoxylan in a ready-to-drink beverage product prepared by diluting the beverage concentrate by a 1-plus-5 throw with water.

Another aspect of the invention is directed to a method of improving taste attributes of a low-calorie or zero-calorie beverage, comprising adding to a low calorie or zero calorie beverage a composition for improving mouthfeel of beverages as described above.

### Sweeteners

The sweeteners included in the beverage compositions disclosed herein are edible consumables. The sweetener can be a nutritive or non-nutritive, natural or synthetic sweetener, or a combination of such sweeteners, so long as the sweetener or combination of sweeteners provides a taste which is perceived as sweet by the sense of taste. The perception of flavoring agents and sweetening agents can depend to some extent on the interrelation of elements. Flavor and sweetness can also be perceived separately, i.e., flavor and sweetness perception can be both dependent upon each other and independent of each other. For example, when a large amount of a flavoring agent is used, a small amount of a sweetening agent can be readily perceptible and vice versa. Thus, the oral and olfactory interaction between a flavoring agent and a sweetening agent can involve the interrelationship of elements.

When used to sweeten, the sweetener or combination of sweeteners in the beverage composition is present in an amount above the sweeteners' sweetness recognition threshold concentration.

In certain embodiments, non-nutritive sweeteners can be present in the beverage composition in an amount ranging from about 1 ppm to about 600 ppm (e.g., about 1 ppm, about 10 ppm, about 50 ppm, about 100 ppm, about 200 ppm, about 300 ppm, about 400 ppm, about 500 ppm, about 600 ppm, or any ranges between the recited values), depending upon the particular non-nutritive sweetener(s) being used and the desired level of sweetness in the beverage composition.

Other sweeteners suitable for use in the beverage composition herein include, but are not limited to, sugar alcohols such as erythritol, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, and mixtures thereof.

Other sweeteners suitable for use in the beverage composition herein include rare sugars such as D-allose, D-psicose (also known as D-allulose), L-ribose, D-tagatose, L-glucose, L-fucose, L-arabinose, D-turanose, D-leucrose, and mixtures thereof.

Exemplary artificial sweeteners suitable for use in the beverage composition herein include, but are not limited to, saccharin, cyclamate, aspartame, neotame, advantame, acesulfame potassium, sucralose, mixtures thereof.

Exemplary natural non-nutritive potent sweeteners suitable for use in the beverage composition herein include steviol glycosides (e.g., stevioside, steviolbioside, rebaudioside A, rebaudioside B, rebaudioside C, rebaudioside D, rebaudioside E, rebaudioside F, rebaudioside H, rebaudioside I, rebaudioside N, rebaudioside K, rebaudioside J, rebaudioside O, rebaudioside M, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, mabinlins I and II, and mixtures thereof.

In certain embodiments, one or more nutritive sweeteners can be present in the beverage composition in an amount of from about 1% to about 20% by weight of the beverage composition, such as from about 3% to about 16% by weight, or from about 5% to about 12% by weight, depending upon the desired level of sweetness in the beverage composition.

In other embodiments, Lo Han Guo juice concentrate can be used as a nutritive sweetener in the beverage composition herein.

In some embodiments, the sweetener is selected from the group consisting of a steviol glycoside, Stevia rebaudiana extracts, Lo Han Guo, Lo Han Guo juice concentrate, Lo Han Guo powder, mogroside V, thaumatin, monellin, brazzein, monatin, erythritol, tagatose, sucrose, liquid sucrose, fructose, liquid fructose, glucose, liquid glucose, high fructose com syrup, invert sugar, medium invert sugar, maple syrup, maple sugar, honey, chicory syrup, Agave syrup, brown sugar molasses, cane molasses, sugar beet molasses, sorghum syrup, sorbitol, mannitol, maltitol, xylitol, glycyrrhizin, malitol, maltose, lactose, xylose, arabinose, isomalt, lactitol, trehalulose, ribose, fructo-oligosaccharides, aspartame, neotame, alitame, sodium saccharin, calcium saccharin, acesulfame potassium, sodium cyclamate, calcium cyclamate, neohesperidin dihydrochalcone, sucralose, polydextrose, and mixtures of any of them.

In some embodiments, the sweetener is a non-nutritive sweetener. In some embodiments, the sweetener is a natural non-nutritive sweetener selected from the group consisting of rebaudioside A, rebaudioside B, rebaudioside C, rebaudioside D, rebaudioside M, iso-steviol glycosides, mogrosides, trilobatin, and combinations thereof. In some embodiments, the sweetener is aspartame, acesulfame potassium, steviol glycosides, or any combinations thereof.

Other suitable sweeteners that can be used in the beverage composition herein are known in the art, for example, as described in WO 2016/040577 A1. In certain embodiments, combinations of one or more natural nutritive sweeteners, one or more artificial sweeteners, and/or one or more natural non-nutritive potent sweeteners can be used.

### Sweetness Enhancer

In certain embodiments, the beverage composition further comprises a sweetness enhancer.

In certain embodiments, the sweetness enhancer can be present at a concentration below its sweetness recognition threshold concentration. For example, and in certain embodiments, the beverage composition can contain up to about 2 weight percent each of D-psicose, erythritol, or combination thereof. In some embodiments, D-psicose and/or erythritol can be present in an amount ranging from about 0.5 to about 2.0 weight percent. Alternatively, D-psicose can be present in an amount ranging from about 0.5 to about 2.0 weight percent and erythritol can be present in an amount ranging from about 0.5 to about 1 weight percent.

Suitable sweetness enhancers include any of those known in the art. Exemplary sweetness enhancers include, but are not limited to, D-psicose, erythritol, iso-rebaudioside A, rebaudioside B, rebaudioside C, rubusoside, trilobatin, phyllodulcin, brazzein, and/or mogrosides.

In some embodiments, the sweetness enhancer can be a rare sugar sweetness enhancer. Exemplary rare sugars include D-psicose (also referred to as D-allulose), D-allose, L-ribose, D-tagatose, L-glucose, L-fucose, L-arabinose, D-turanose, D-leucrose, and mixtures thereof.

In some embodiments, the sweetness enhancer can be a non-nutritive natural enhancer. Suitable non-nutritive natural enhancers include steviol glycosides. Suitable steviol glycosides, include, but are not limited to, stevioside, rebaudioside A, rebaudioside B, rebaudioside C, rebaudioside D, rebaudioside E, rebaudioside F, rebaudioside H, rebaudioside I, rebaudioside N, rebaudioside K, rebaudioside J, rebaudioside O, rebaudioside M, rubusoside, dulcoside A, iso-steviol glycosides such as iso-rebaudioside A, and mixtures thereof. In a particular embodiment, the sweetness enhancer can be rubusoside, rebaudioside C or rebaudioside B. In other embodiments, the non-nutritive natural sweetness enhancer can be a mogrol glycoside. Suitable mogrol glycosides, include, but are not limited to, mogroside V, isomogroside, mogroside IV, siamenoside, and mixtures thereof.

In some embodiments, the sweetness enhancer can be a sugar alcohol sweetness enhancer. Suitable sugar alcohols include erythritol, sorbitol, mannitol, xylitol, lactitol, isomalt, malitol, and mixture thereof.

In some embodiments, the sweetness enhancer can be a FEMA GRAS sweetness enhancers. Suitable FEMA GRAS enhancers include, but are not limited to, FEMA GRAS enhancer 4802, FEMA GRAS enhancer 4469, FEMA GRAS flavor 4701, FEMA GRAS enhancer 4720 (rebaudioside C), FEMA GRAS flavor 4774, FEMA GRAS enhancer 4708, FEMA GRAS enhancer 4728, FEMA GRAS enhancer 4601 (rebaudioside A) and combinations thereof.

In some embodiments, the sweetness enhancer is a salt based (e.g., NaCl) or benzoic acid based sweetness enhancer.

Other suitable sweetness enhancers are known in the art, for example, as described in WO 2016/040577 A1, in U.S. Patent Application Publication Nos. 2014/0271996, US 2014/0093630, 2014/0094453, and 2014/0272068, along with U.S. Pat. No. 8,877,922, all of which are incorporated by reference in their entireties.

### Aqueous Beverage Compositions

In other embodiments, the beverage composition can be provided in an aqueous formulation, the formulation comprising water, a sweetener, and a mouthfeel enhancing mixture of hydrolyzed beta-glucan and hydrolyzed arabinoxylan. In certain embodiments, the sweetener is a nutritive sweetener, a non-nutritive sweetener, or a combination thereof. Other suitable compounds of Formula I and sweeteners are described herein. In certain embodiments, the aqueous formulation can further include a sweetener enhancer as described herein.

The beverage composition described herein, whether a dry blend or in liquid form (e.g., aqueous form), can be utilized in any food or beverage product typically including a sweetener, including, but not limited to, those discussed throughout this disclosure. In some embodiments, the beverage composition described herein is also suitable for use in cooking, baking (i.e. for use in cookies, cakes, pies, brownies, breads, granola bars, etc.), for preparing sweetened toppings, such as icings, and for use in jellies, jams, preserves, Instant QUAKER Oats, and the like. It is similarly suitable for use in frozen dairy products, such as ice cream, as well as in whipped toppings. Although in certain embodiments, the beverage composition can be dissolved in the food or beverage, in other embodiments, the beverage composition can be present in the food or beverage as part of a suspension or emulsion.

### Beverage Products

In certain embodiments, the beverage composition is provided as a ready-to-drink beverage. In certain embodiments, the beverage composition is provided as a beverage concentrate. In some embodiments, the beverage product is a low-calorie or a zero-calorie beverage product.

### Ready-to-Drink Beverages

Certain embodiments of the present disclosure are directed to ready-to-drink beverages comprising water, a beverage composition comprising a sweetener and a mouthfeel enhancing mixture of hydrolyzed beta-glucan and hydrolyzed arabinoxylan, and optionally an acidulant. In some embodiments, the acidulant is selected from the group consisting of phosphoric acid, citric acid, malic acid, tartaric acid, lactic acid, formic acid, ascorbic acid, fumaric acid, gluconic acid, succinic acid, maleic acid, adipic acid, and mixtures thereof.

In certain embodiments, the ready-to-drink beverage comprises one or more nutritive sweeteners. In some embodiments, the one or more nutritive sweeteners can be present in the ready-to-drink beverage in an amount of from about 1% to about 20% by weight of the beverage composition, such as from about 3% to about 16% by weight, or from about 5% to about 12% by weight, depending upon the desired level of sweetness in the beverage.

In certain embodiments, the ready-to-drink beverage comprises a non-nutritive sweetener. In some embodiments, the non-nutritive sweetener can be present in the ready-to-drink beverage in an amount ranging from about 1 to about 600 ppm (e.g., about 1 ppm, about 10 ppm, about 50 ppm, about 100 ppm, about 200 ppm, about 300 ppm, about 400 ppm, about 500 ppm, about 600 ppm, or any ranges between the recited values), depending upon the particular non-nutritive sweetener(s) being used and the desired level of sweetness in the beverage.

The ready-to-drink beverage can further comprise one or more sweetness enhancers. In certain embodiments, the sweetness enhancer can be present at a concentration below its sweetness recognition threshold concentration. For example, and in certain embodiments, the ready-to-drink beverage can contain up to about 2 weight percent each of D-psicose, erythritol, or combination thereof. In some embodiments, D-psicose and/or erythritol can be present in an amount ranging from about 0.5 to about 2.0 weight percent. Alternatively, D-psicose can be present in an amount ranging from about 0.5 to about 2.0 weight percent and erythritol can be present in an amount ranging from about 0.5 to about 1 weight percent.

In certain embodiments, the ready-to-drink beverage can also include one or more salts. In other embodiments, salt concentration can range from about 100 ppm to about 1000 ppm, or in a further embodiment from about 200 ppm to about 800 ppm. In particular embodiments, the salt can be sodium chloride. In certain embodiments, the beverage composition can be completely or substantially salt free.

In certain embodiments, the ready-to-drink beverage can further comprise other ingredients such as antioxidants, food grade acids, and food grade bases. Other beverage components such as flavorants, colors, preservatives, carbon dioxide, buffering salts, and the like, can also be present.

In certain embodiments, the ready-to-drink beverages can be carbonated and non-carbonated soft drinks, fountain beverages, frozen ready-to-drink beverages, coffee, tea, and other brewed beverages, dairy beverages, flavored waters, enhanced waters, juices such as fruit juice (including diluted and ready to drink concentrated juices), fruit juice-flavored drinks, sport drinks, smoothies, functionally enhanced beverages such as caffeinated energy drinks, and alcoholic products. In particular embodiments, the beverage composition can be a cola beverage.

It should be understood that beverages and other beverage products in accordance with this disclosure can have any of numerous different specific formulations or constitutions. The formulation of a beverage product in accordance with this disclosure can vary, depending upon such factors as the product's intended market segment, its desired nutritional characteristics, flavor profile, and the like. For example, further ingredients can be added to the formulation of a particular beverage embodiment. Further ingredients include, but are not limited to, one or more additional sweeteners in addition to any sweetener already present, flavorings, electrolytes, vitamins, fruit juices or other fruit products, tastants, masking agents, flavor enhancers, carbonation, or any combination of the foregoing. These can be added to any of the beverage compositions to vary the taste, and/or nutritional characteristics of the beverage composition.

In certain embodiments, a ready-to-drink beverage in accordance with this disclosure can comprise water, a sweetener, a mouthfeel enhancing mixture of hydrolyzed beta-glucan and hydrolyzed arabinoxylan, an acidulant, and a flavoring. Exemplary suitable acidulants include, but are not limited to, phosphoric acid, citric acid, malic acid, tartaric acid, lactic acid, formic acid, ascorbic acid, fumaric acid, gluconic acid, succinic acid, maleic acid, adipic acid, and mixtures thereof. Exemplary flavorings include, but are not limited to, cola flavoring, citrus flavoring, spice flavorings, tea flavoring, coffee flavoring, juice flavoring, and combinations thereof. Carbonation in the form of carbon dioxide can be added for effervescence. In some embodiments, the water is carbonated water. In certain embodiments, preservatives can be added if desired or necessary, depending upon factors including the presence of other ingredients, production technique, desired shelf life, etc. In certain embodiments, caffeine can be added to the beverage. In certain embodiments, the beverage is substantially caffeine free (e.g., less than 1% by weight, less than 0.1% by weight, less than 0.01% by weight, less than 0.001% by weight, or less than 0.0001% by weight). In certain embodiments, the beverage is caffeine free. In some embodiments, the ready-to-drink beverage is a low-calorie or a zero-calorie beverage. Other suitable compounds are described herein.

Certain exemplary embodiments of the beverages disclosed here are cola-flavored carbonated beverages, characteristically containing, in addition to the ingredients included in the beverage compositions disclosed herein, carbonated water, sweetener, kola nut extract and/or other flavorings, caramel coloring, phosphoric acid, and optionally other ingredients. Additional and alternative suitable ingredients will be recognized by those skilled in the art given the benefit of this disclosure.

### Beverage Concentrates

Beverages are typically not prepared in large batches. Instead, a syrup (alternatively referred to as a beverage concentrate or concentrate), water, and optionally carbon dioxide are combined at the time of use or at the time of bottling or dispensing a beverage. The syrup is a concentrated solution of many of the soluble ingredients typically included in a given beverage.

Thus, in certain embodiments, the beverage compositions described herein can be provided in a beverage concentrate. At least certain exemplary embodiments of the beverage concentrates contemplated can be prepared with an initial volume of water to which a sweetener and a mouthfeel enhancing mixture of hydrolyzed beta-glucan and hydrolyzed arabinoxylan are added. In certain embodiments, ready-to-drink beverage compositions can be formed from the beverage concentrate by adding further volumes of water to the concentrate. In certain embodiments, a ready-to-drink beverage can be prepared from a concentrate by combining approximately 1 part concentrate with about 3 to about 7 parts water. In certain embodiments, the ready-to-drink beverage can be prepared by combining 1 part concentrate with 5 parts water. In certain exemplary embodiments the water added to the concentrate to form the ready-to-drink beverages can be carbonated.

The amounts of the mouthfeel enhancing mixture of hydrolyzed beta-glucan and hydrolyzed arabinoxylan, sweetener and other ingredients present in the beverage concentrate are typically about 3 fold to about 7 fold of the respective amounts present in the ready-to-drink beverage as discussed herein.

Similarly, in certain embodiments, the beverage concentrate can comprise a nutritive sweetener at from about 6% to about 71% by weight of the beverage concentrate, such as from about 18% to about 62% by weight, or from about 30% to about 45% by weight, depending upon the desired level of sweetness for the ready-to-drink beverage.

In certain embodiments, the beverage concentrate can comprise non-nutritive sweetener at from about 6 ppm to about 3600 ppm depending upon the particular non-nutritive sweetener being used and the desired level of sweetness for the ready-to-drink beverage.

In certain embodiments, the syrups can further comprise a sweetness enhancers in an amount such that the concentration of the sweetness enhancer will be below its sweetness recognition threshold concentration in a ready-to-drink beverage.

For example, in certain embodiments, the syrup can contain up to about 18 weight percent of D-psicose, erythritol, or combination thereof. In other embodiments, D-psicose or erythritol can be present in an amount of from about 3 to about 9 weight percent. Alternatively, D-psicose can be present in an amount ranging from about 3 to about 9 weight percent and erythritol can be present in an amount of from about 3 to about 6 weight percent.

In certain embodiments, one or more salts can be included in the syrup. In certain embodiments the salt concentration in the syrup ranges from about 600 ppm to about 6000 ppm, and in certain embodiments, from about 1200 ppm to about 2400 ppm. In certain embodiments, the syrup can be completely or substantially salt free.

### Water

Water is a basic ingredient in the aqueous compositions described herein (e.g., beverage products), typically being the vehicle or primary liquid portion in which the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage.

In certain embodiments, water can be present at a level of from about 20 weight percent to about 99.9 weight percent in the aqueous compositions disclosed herein. In certain beverage embodiments, the quantity of water can range from about 80 weight percent to about 99.9 weight percent of the beverage. In at least certain exemplary embodiments the water used in beverages and concentrates disclosed here is “treated water,” which refers to water that has been treated to reduce the total dissolved solids of the water prior to optional supplementation with calcium as disclosed in U.S. Pat. No. 7,052,725, which is incorporated by reference in its entirety.

Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

### Natural Embodiments

Certain embodiments of the described compositions can be “natural” in that they do not contain anything artificial or synthetic (including any color additives regardless of source) that would not normally be expected to be in the food or beverage. As used herein, therefore, a “natural” food or beverage product is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food or beverage component, including clarifying agents, catalysts, flocculants, filter aids, and crystallization inhibitors, etc. See 21 CFR § 170.3(o)(24)) are considered incidental additives and may be used if removed appropriately.

### Additional Ingredients

The beverage products disclosed herein can contain additional ingredients, for example, those typically included in beverage products.

In certain embodiments, the beverage products disclosed herein can contain a flavor composition, for example, natural, nature identical, and/or synthetic fruit flavors, botanical flavors, other flavors, and mixtures thereof. As used herein, the term “fruit flavor” refers generally to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, apple, grape, cherry, and pineapple flavors. In certain embodiments, the food or beverage products comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots, and leaves. Also included within the term “botanical flavor” are synthetically prepared flavors made to simulate botanical flavors derived from natural sources. Examples of such flavors include cola flavors, tea flavors, and mixtures thereof. The flavor component may further comprise a blend of several of the above-mentioned flavors. In certain exemplary embodiments of the beverage products, a cola flavor component is used or a tea flavor component. The particular amount of the flavor component useful for imparting flavor characteristics to the food or beverage products of the present disclosure will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in certain exemplary embodiments of the food or beverage products disclosed herein include, e.g., fruit, vegetable and berry juices. Juices may be employed in the food or beverage products in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a concentrate or beverage having a desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin, melon, watermelon, and grapefruit. Numerous additional and alternative juices suitable for use in at least certain exemplary embodiments will be apparent to those skilled in the art given the benefit of this disclosure. In the compositions of the present disclosure employing juice, juice can be used, for example, at a level of at least about 0.2 weight percent of the composition. In certain embodiments juice can be employed at a level of from about 0.2 weight percent to about 40 weight percent. In further embodiments, juice can be used, if at all, in an amounts ranging from about 1 weight percent to about 20 weight percent.

Juices that are lighter in color can be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the food or beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings may be in the form of an extract, oleoresin, juice concentrate, bottler's base, or other forms known in the art. In at least certain exemplary embodiments, such spice or other flavors complement that of a juice or juice combination.

The one or more flavorings may be used in the form of an emulsion. A flavoring emulsion can be prepared by mixing some or all of the flavorings together, optionally together with other ingredients of the food or beverage, and an emulsifying agent. The emulsifying agent can be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of food or beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide can be used to provide effervescence to certain exemplary embodiments of the food or beverage products disclosed here. Any of the techniques and carbonating equipment known in the art for carbonating beverages can be employed. Carbon dioxide can enhance beverage taste and appearance and may aid in safeguarding the beverage purity by inhibiting and/or destroying objectionable bacteria. In certain embodiments, for example, the beverage can have a CO₂ level up to about 4.0 volumes carbon dioxide. Other embodiments can have, for example, from about 0.5 volume to about 5.0 volumes of carbon dioxide. As used herein, one volume of carbon dioxide refers to the amount of carbon dioxide absorbed by a given quantity of a given liquid, such as water, at 60° F. (16° C.) and one atmospheric pressure. A volume of gas occupies the same space as does the liquid by which it is dissolved. The carbon dioxide content can be selected by those skilled in the art based on the desired level of effervescence and the impact of the carbon dioxide on the taste or mouthfeel of the beverage.

In certain embodiments, caffeine can be added to any of the food or beverage products described herein. The amount of caffeine added can be determined by the desired properties of a given beverage or syrup, and any applicable regulatory provisions of the country where the beverage or syrup is marketed. In certain embodiments caffeine can be included in an amount sufficient to provide a final beverage product having less than about 0.02 weight percent caffeine. The caffeine must be of purity acceptable for use in beverages. The caffeine may be natural or synthetic in origin.

The food or beverage products disclosed here can contain further additional ingredients, including, generally, any of those typically found in food or beverage formulations. Examples of such additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% Recommended Daily Value (RDV), where such RDVs are established. In certain exemplary embodiments the non-mineral nutritional supplement ingredient(s) can be present in an amount of from about 5% to about 20% RDV, where established.

Preservatives may be used in at least certain embodiments of the food or beverage products disclosed here. That is, at least certain exemplary embodiments can contain an optional dissolved preservative system. Solutions with a pH below 4 and especially those below 3 typically are “micro-stable,” i.e., they resist growth of microorganisms, and so are suitable for longer term storage prior to consumption without the need for further preservatives. However, an additional preservative system can be used if desired. If a preservative system is used, it can be added to the product at any suitable time during production, e.g., in some cases prior to the addition of sweeteners. As used here, the terms “preservation system” or “preservatives” include all suitable preservatives approved for use in beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations.

In the case of beverages in particular, the level of preservative used can be adjusted according to the planned final product pH and/or the microbiological spoilage potential of the particular beverage formulation. The maximum level employed typically is about 0.05 weight percent of the beverage. It will be within the ability of those skilled in the art, given the benefit of this disclosure, to select a suitable preservative or combination of preservatives for food or beverage products according to this disclosure.

Other methods of preservation suitable for at least certain exemplary embodiments of the products disclosed here include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 discloses the use of pasteurization in the production of fruit juice beverages as well as the use of suitable preservatives in carbonated beverages. U.S. Pat. No. 4,925,686 discloses a heat-pasteurized freezable fruit juice composition which contains sodium benzoate and potassium sorbate. Both of these patents are incorporated by reference in their entireties. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

Suitable antioxidants may be selected from the group consisting of rutin, quercetin, flavonones, flavones, dihydroflavonols, flavonols, flavandiols, leucoanthocyanidins, flavonol glycosides, flavonone glycosides, isoflavonoids, and neoflavonoids. In particular, the flavonoids may be, but not limited to, quercetin, eriocitrin, neoeriocitrin, narirutin, naringin, hesperidin, hesperetin, neohesperidin, neoponcirin, poncirin, rutin, isorhoifolin, rhoifolin, diosmin, neodiosmin, sinensetin, nobiletin, tangeritin, catechin, catechin gallate, epigallocatechin, epigallocatechin gallate, oolong tea polymerized polyphenol, anthocyanin, heptamethoxyflavone, daidzin, daidzein, biochaminn A, prunetin, genistin, glycitein, glycitin, genistein, 6,7,4′ trihydroxy isoflavone, morin, apigenin, vitexin, balcalein, apiin, cupressuflavone, datiscetin, diosmetin, fisetin, galangin, gossypetin, geraldol, hinokiflavone, primuletin, pratol, luteolin, myricetin, orientin, robinetin, quercetagetin, and hydroxy-4-flavone.

Suitable food grade acids are water soluble organic acids and their salts and include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the food or beverage.

Suitable food grade bases are sodium hydroxide, potassium hydroxide, and calcium hydroxide. Such bases also are suitable for adjusting the pH of a food or beverage.

### EXAMPLES

### Production of Ezymatically Hydrolyzed β-Glucan (βG) and Arabinoxylan (ARX)

β-glucan (βG) having an average molecular weight of approximately 350,000 Daltons was obtained from Oat bran. Arabinoxylan (ARX) having an average molecular weight of approximately 350,000 Daltons was obtained from Wheat bran. Enzyme treatment for both hydrolyzed β-glucan (βG) and arabinoxylan (ARX) was performed for five minutes in separate reaction vessels. The enzyme in each mixture was inactivated by boiling for 10 minutes. Starting material for β-glucan (βG) substrate includes crude beta glucan of molecular weight 1 million daltons. This substrate can be obtained from oat bran. Starting material for arabinoxylan (ARX) substrate includes crude arabinoxylan of molecular weight >750,000 daltons. This substrate can be obtained from wheat bran. A suitable starting substrate concentration of polysaccharide was 20 mg/ml in each instance. A cellulase was used for β-glucan and a hemicellulase was used for arabinoxylan. Both are food grade and non-GMO.

The enzymatic treatment for both polymers was thereafter varied for both polymers. The treatment can be performed to a degree to which a combination of the two polymers as a mixture results in the analytically desired viscosity and lubrication.

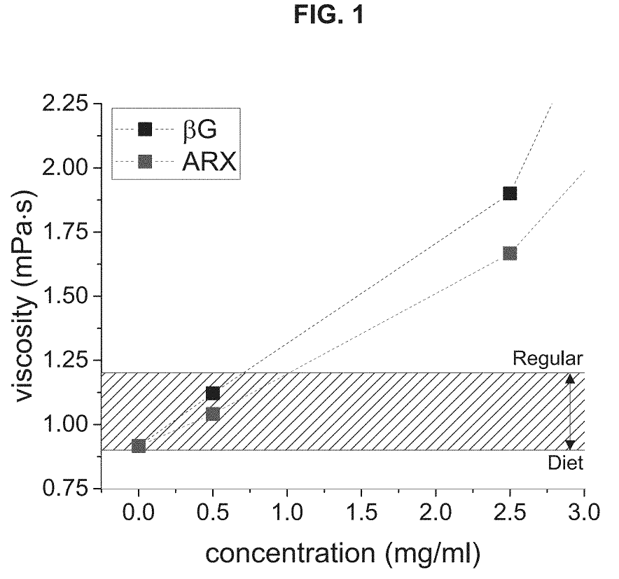

FIG. 1 shows viscosity profiles for β-glucan and arabinoxylan in citric buffer solution and a viscosity gap between mock Regular and mock Diet. The concentration necessary to be added to mock Diet to achieve the mock Regular viscosity can be estimated from the interpolated broken lines. The interpolation indicates that although both polymers are capable of increasing viscosity, β-glucan is the stronger viscosifying agent at a given concentration when used alone.

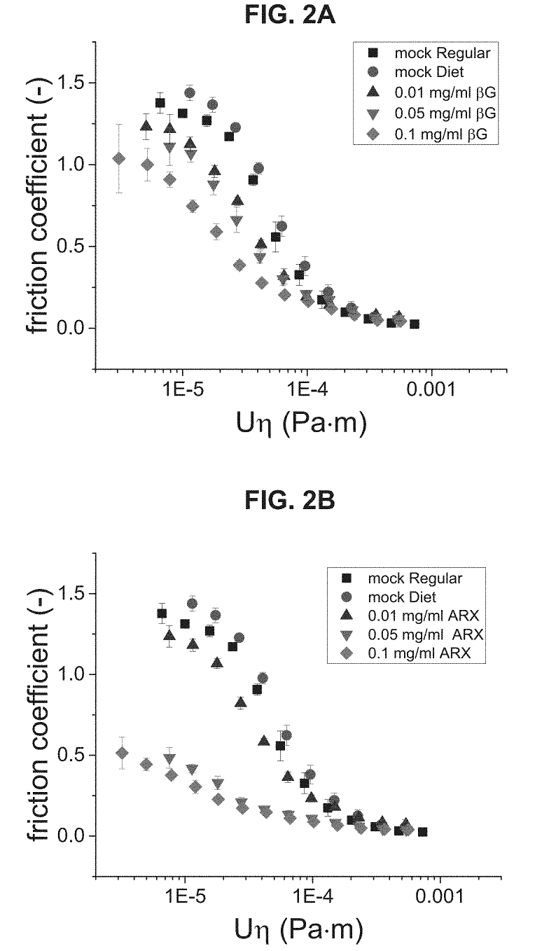

In FIG. 2, lubrication profiles for β-glucan (βG) and arabinoxylan (ARX) in mock Diet are shown at varying concentrations as well as the lubrication profiles for mock Regular (black) and mock Diet (red). The figure indicates that i) mock Diet is less lubricating than mock Regular and ii) the system becomes more lubricating with a higher concentration of polymers, and iii) arabinoxylan is stronger lubricating agent at a given concentration when used alone. Hence, an addition of the polymers into mock Diet can match its lubrication profile to that of mock Regular.

Blending Hydrolyzed β-Glucan (βG) and Arabinoxylan (ARX)

There are some factors to consider when creating blends of the hydrolyzed β-glucan (βG) and arabinoxylan (ARX). First, too large polymeric weights of either β-glucan (βG) or arabinoxylan (ARX) can result in high viscosities and/or excessive lubrication, which may be perceived as being too bulky or too slimy in mouthfeel terms. Secondly, no single polymer (either the hydrolyzed β-glucan (βG) or the hydrolyzed arabinoxylan (ARX)) can effectively match both viscosity and lubrication to the target value at a given concentration. One polymer may be a good lubricating agent but not add too much of a viscosity and vice versa. This is important because both viscosity and lubrication need to be adjusted congruently to the target value under a given condition and it is impossible to control completely independently one or the other.

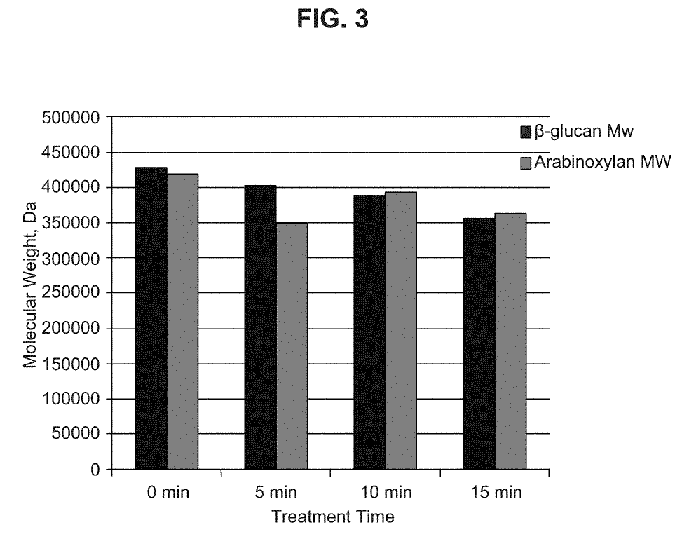

To achieve having an acceptable mouthfeel, an enzyme treatment and a balancing of blend concentrations are utilized. The enzyme treatment provides a controlled molecular weight reduction, via which the aforementioned impediments are greatly minimized and the desired beverage bulking and syrup-like mouthfeel are generated. The controlled molecular weight reduction can be realized either by controlling the dosage (Table 1) and/or by controlling the time at specified dosage (FIG. 3). Molecular weight was determined as true or absolute molecular weight using triple detection size exclusion chromatography employing principles of light scattering and viscometry.

TABLE 1
Dosage effect on controlled molecular weight
reduction via enzyme treatment

| Treament (Dosage | β-glucan | Arabinoxylan |
|---|---|---|
| of enzyme per 20 | Mol. Wt. | Mol. Wt. |
| mg of substrate)** | (avg), Da | (avg), Da |
| 0 μg | 327,370 | 356,430 |
| 0.1 μg | 282,073 | 365,977 |
| 1 μg | 175,203 | 321,473 |
| 100 μg | 7,822 | 107,658 |

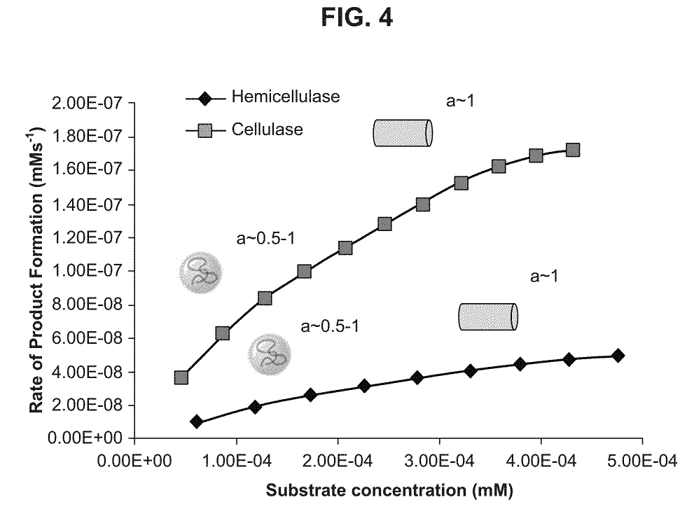

Besides controlling molecular weight, enzyme kinetics controls structural orientation as well (FIG. 4). On a prolonged treatment, i.e. with increasing degree of hydrolysis, randomly-coiled parent polymeric molecules are frequently transformed to cylindrical (rod like) more regularly-aligned chains. The increase in exponent value, a (derived from viscometry and light scattering coupled to RI detection), in FIG. 4 signifies that transformation. This ability to manipulate structural orientation allows for control of lubrication primarily. Conversely, the reduction of molecular weight allows for control of viscosity, primarily.

Thus, the enzymatic treatment for both polymers is to be performed to a degree to which provides a combination of the two results in the analytically desired viscosity and lubrication.

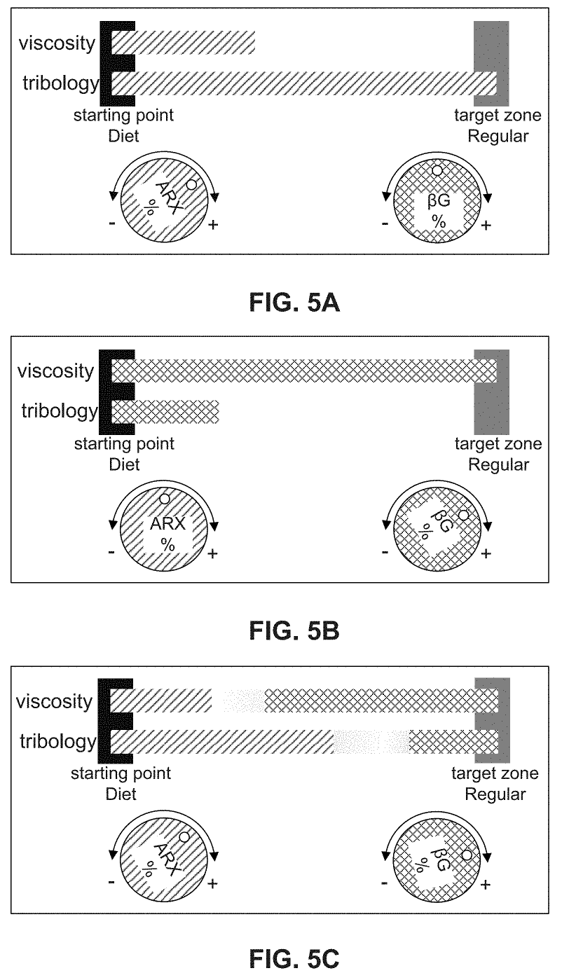

Though enzymatic hydrolysis allows for control over the desired properties, combining/blending the two hydrolysis products provides another dimension to compositions of the present disclosure. The careful crafting of blends of hydrolyzed β-glucan and hydrolyzed arabinoxylan complements each other's lubrication and viscosification capabilities. As shown in FIG. 5, arabinoxylan is a strong lubrication agent but less effective with viscosity and the opposite is true for beta glucan. Hence, blending the two polymers provides for compositions having an enhanced mouthfeel that cannot be achieved by either hydrolyzed polymer alone. Moreover, the degree by which viscosity and lubrication are to be varied is intrinsically different. For example, lubrication may need a minute adjustment while viscosity needs a significant increase. For this reason, the amount enzyme addition and duration of hydrolysis, as well as the polymer concentration are all parameters that can be adjusted to obtain mouthfeel enhancing blends of the present disclosure.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

All of the various aspects, embodiments, and options described herein can be combined in any and all variations.

All publications, patents, and patent applications mentioned in this specification are herein incorporated by reference to the same extent as if each individual publication, patent, or patent application was specifically and individually indicated to be incorporated by reference.

1. A composition for improving mouthfeel of beverages, comprising:
a hydrolyzed beta-glucan characterized by an average molecular weight (Mw) of about 50,000 to 350,000; and
a hydrolyzed arabinoxylan, characterized by an average molecular weight (Mw) of about 50,000 to about 350,000.

2. The composition of claim 1, wherein the hydrolyzed beta-glucan is characterized by an average molecular weight (Mw) of about 100,000 to 300,000.

3. The composition of claim 1, wherein the hydrolyzed arabinoxylan is characterized by an average molecular weight (Mw) of about 100,000 to about 300,000.

4. The composition of claim 1, wherein one or both of the hydrolyzed beta-glucan and hydrolyzed arabinoxylan are enzymatically hydrolyzed beta-glucan and enzymatically hydrolyzed arabinoxylan.

5. The composition of claim 1, wherein the hydrolyzed beta-glucan and the hydrolyzed arabinoxylan are present in a weight ratio ranging from about 10:1 to about 1:10.

6. (canceled)

7. (canceled)

8. The composition of claim 4, wherein the enzymatically hydrolyzed beta-glucan is endocellulase hydrolyzed beta-glucan or endo-beta-glucanase hydrolyzed beta-glucan.

9. (canceled)

10. The composition of claim 4, wherein the enzymatically hydrolyzed arabinoxylan is endo-aribinase hydrolyzed arabinoxylan or endo-xylanase hydrolyzed arabinoxylan.

11. A beverage composition, comprising:
water;
a non-nutritive sweetener; and
a composition of claim 1.

12. The beverage composition of claim 11, wherein the composition is a low-calorie or zero-calorie beverage product.

13. The beverage composition of claim 11, wherein said non-nutritive sweetener is selected from the group consisting of aspartame, acesulfame salts, saccharins, cyclamates, sucralose, alitame, neotame, steviosides, glycyrrhizin, Lo Han Guo, neohesperidin dihydrochalcone, monatin, monellin, thaumatin, brazzein, and mixtures thereof.

14-18. (canceled)

19. The beverage composition of claim 11, wherein the beverage has a pH ranging from about 2 to about 5, and further comprises
an acidulant selected from the group consisting of phosphoric acid, citric acid, malic acid, tartaric acid, lactic acid, formic acid, ascorbic acid, fumaric acid, gluconic acid, succinic acid, maleic acid, adipic acid, and mixtures thereof.

20. (canceled)

21. The beverage composition of claim 11, further comprising at least one additive selected from the group consisting of a tea flavorant, a coffee flavorant, a fruit juice, and caffeine.

22-25. (canceled)

26. The beverage composition of claim 11, wherein the hydrolyzed beta-glucan and hydrolyzed arabinoxylan are enzymatically hydrolyzed beta-glucan and enzymatically hydrolyzed arabinoxylan, and wherein the enzymatically hydrolyzed beta-glucan is present in an amount of about 0.1 mg/mL to about 5 mg/mL; and wherein the enzymatically hydrolyzed arabinoxylan is present in an amount of about 0.1 mg/mL to about 5 mg/mL.

27. The beverage composition of claim 11, wherein the beverage has a viscosity in the range of about 0.5 to about 5 cP, and a coefficient of friction in the range of about 0.001 to about 2 when 50 Duro PDMS sphere and disc are used as measurement rigs on a PCS Instruments MTM2 tribometer at a normal load of 2.0 N, and/or a contact angle in the range of about 50 to about 80°.

28. The beverage composition of claim 11, wherein the composition is a beverage concentrate.

29. The beverage concentrate of claim 28, wherein the hydrolyzed beta-glucan is enzymatically hydrolyzed beta-glucan, and wherein the enzymatically hydrolyzed beta-glucan is present in an amount sufficient to provide about 0.1 mg/mL to about 5 mg/mL of the beta-glucan in a ready-to-drink beverage product prepared by diluting the beverage concentrate by a 1-plus-5 throw with water.

30. The beverage concentrate of claim 28, wherein the hydrolyzed arabinoxylan is enzymatically hydrolyzed arabinoxylan, and wherein the enzymatically hydrolyzed arabinoxylan is present in an amount sufficient to provide about 0.1 mg/mL to about 5 mg/mL of the arabinoxylan in a ready-to-drink beverage product prepared by diluting the beverage concentrate by a 1-plus-5 throw with water.

31-34. (canceled)

35. A method of improving taste attributes of a low-calorie or zero-calorie beverage, comprising adding to a low calorie or zero calorie beverage
a hydrolyzed beta-glucan characterized by an average molecular weight (Mw) of about 50,000 to 350,000; and
a hydrolyzed arabinoxylan, characterized by an average molecular weight (Mw) of about 50,000 to about 350,000.

36. The method of claim 35, wherein the hydrolyzed beta-glucan and hydrolyzed arabinoxylan are enzymatically hydrolyzed beta-glucan and enzymatically hydrolyzed arabinoxylan, and wherein the enzymatically hydrolyzed beta-glucan is added in an amount of about 0.1 mg/mL to about 5 mg/mL; and wherein the enzymatically hydrolyzed arabinoxylan is added in an amount of about 0.1 mg/mL to about 5 mg/mL.

37. (canceled)

38. The method of claim 35, wherein the low-calorie or zero-calorie beverage has a viscosity in the range of about 0.5 to about 5 cP, and a coefficient of friction in the range of about 0.001 to about 2 when 50 Duro PDMS sphere and disc are used as measurement rigs on a PCS Instruments MTM2 tribometer at a normal load of 2.0 N and/or a contact angle in the range of about 50 to about 80°.

39. (canceled)
